(19) United States
(12) Patent Application Publication
(10) Pub. No.: US 2004/0268226 A1
(43) Pub. Date: Dec. 30, 2004

(54) Facilitating the development of computer programs

(75) Inventor: Angelina McMullin, Longmont, CO (US)

Correspondence Address: HESLIN ROTHENBERG FARLEY & MESITI P.C., 5 COLUMBIA CIRCLE, ALBANY, NY, 12203, US

(73) Assignee: International Business Machines Corporation, Armonk, New York

(21) Appl. No.: 10/607,127

(22) Filed: Jun. 26, 2003

(51) Int. Cl. G06F 15/00

(52) U.S. Cl. 715/503

(57) ABSTRACT

Development of computer programs is facilitated. An interface of a program is created and that program interface encapsulates an existing spreadsheet, such that the spreadsheet itself is the calculation engine of the program. The logic of the spreadsheet is not re-coded, and the spreadsheet is hidden from and unchangeable by the user. The interface provides exclusive input and output access to the spreadsheet.

### TECHNICAL FIELD

This invention relates, in general, to computer programming, and in particular, to facilitating the development of computer programs.

### BACKGROUND OF THE INVENTION

A computer program is developed to provide certain functionality requested by one or more users. This functionality is capable of being described to the programmer in various ways. In one example, a programmer is presented with a spreadsheet that details the functionality desired by the user.

Spreadsheets are tools for many areas of business, including the information technology industry. Valuable and critical business logic can be built into a spreadsheet. This logic typically includes a number of calculations, one or more of which are quite complex. Often, it is beneficial to capture this logic in a program in order to provide a controlled environment for the logic and to provide additional functionality.

To provide the logic of a spreadsheet in a computer program, the programmer analyzes the logic of the spreadsheet (e.g., formulas, business calculations/estimates, and business modeling) and re-codes the logic, including the calculation formulas, in a program format. This is very labor intensive, time consuming, expensive and error-prone.

Based on the foregoing, a need exists for a capability that enables the functionality of a spreadsheet to be captured in a program without requiring the re-coding of the spreadsheet. In particular, a need exists for a capability that facilitates the development of programs that are based on spreadsheets. A further need exists for a capability that facilitates access to spreadsheets.

### SUMMARY OF THE INVENTION

The shortcomings of the prior art are overcome and additional advantages are provided through the provision of a method of facilitating development of programs. The method includes, for instance, providing an interface of a program; and including in the program a spreadsheet that is to execute logic of the spreadsheet in response to data of the interface, wherein the spreadsheet of the program is unchangeable by a user.

In a further aspect of the present invention, a method of facilitating access to spreadsheets is provided. The method includes, for instance, using an interface to provide data to a spreadsheet, the interface providing exclusive input access to the spreadsheet; and using the interface to obtain data from the spreadsheet, the interface providing exclusive output access to the spreadsheet.

System and computer program products corresponding to the above-summarized methods are also described and claimed herein.

Additional features and advantages are realized through the techniques of the present invention. Other embodiments and aspects of the invention are described in detail herein and are considered a part of the claimed invention.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 depicts one embodiment of a computing environment incorporating and using one or more aspects of the present invention;

FIG. 2 depicts one embodiment of the logic associated with developing a program, in accordance with an aspect of the present invention;

FIG. 3 depicts one embodiment of the logic associated with creating an application interface of the program being developed, in accordance with an aspect of the present invention;

FIG. 4 depicts one embodiment of the logic associated with encapsulating a spreadsheet with the application interface of FIG. 3, in accordance with an aspect of the present invention;

FIG. 5 depicts one embodiment of the logic associated with coding the interaction between the inputs of the application interface and the inputs of the spreadsheet, in accordance with an aspect of the present invention; and

FIG. 6 depicts one embodiment of the logic associated with using the developed program, in accordance with an aspect of the present invention.

### BEST MODE FOR CARRYING OUT THE INVENTION

In accordance with an aspect of the present invention, a capability is provided for facilitating the development of programs. As one example, a program is created by encapsulating a given spreadsheet with an application interface and using the spreadsheet itself as a calculation engine of the program. The program need not re-code the logic (e.g., formulas, calculations/estimates, business model) of the spreadsheet, but instead, uses the spreadsheet itself to perform the logic (e.g., perform calculations). The application interface is used to provide the look and feel of a program, provide various controls and to hide the spreadsheet. The users are unaware that the spreadsheet is being used as the calculation engine of the program.

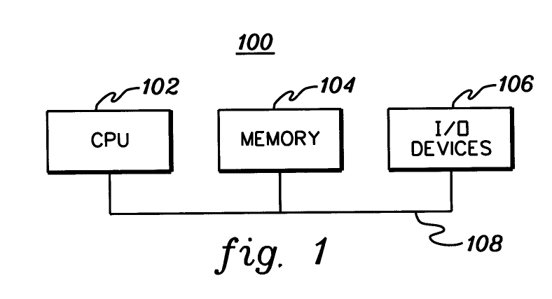

One embodiment of a computing environment to incorporate and use one or more aspects of the present invention is described with reference to FIG. 1. A computing environment 100 includes, for instance, a central processing unit 102, a memory 104 (e.g., main memory) and one or more input/output (I/O) devices 106 coupled to one another via, for example, one or more buses 108.

As one example, computing environment 100 includes a personal computer, such as a ThinkPad offered by International Business Machines Corporation, Armonk, N.Y., which executes Windows 2000, offered by Microsoft Corporation, Redmond, Wash. In this example, computing environment 100 also executes the Visual Basic programming language (e.g., Visual Basic 6) and the Excel 2000 spreadsheet program also offered by Microsoft Corporation.

In accordance with an aspect of the present invention,Visual Basic 6 is employed to develop a program based on a given spreadsheet, such as an Excel spreadsheet. The program developed is to include the spreadsheet, which is to be hidden and unchangeable by the user. To facilitate hiding the spreadsheet, the spreadsheet is password protected. In order to password protect the spreadsheet, the following steps are performed, in one example:

1. In the spreadsheet, perform a Save-As, then in the dialog that appears in the upper right hand corner of the screen, choose Tools-General Options. Enter “xxxx” as the password to open. Say OK. It will request the password a second time. Do so. Now click on the Save button.

2. Get into the Visual Basic for Applications (VBA) code for the spreadsheet by clicking Tools|Macro|VB Editor. If the Project Explorer is not visible, click View|Project Explorer.

3. If the file is without password protection or encryption, skip this step . . . Right-click the VBA Project, click VBAProject properties, then click Protection tab. Find the “Lock project for viewing” checkbox, verify it is UNchecked. Click OK. (This should not have to be done, if the spreadsheet is without password protection or encryption. Instead, try to open the Results module. If it is locked, it will ask for the password then.)

4. Find the Worksheet_Activate routing in the Sheet#(Results) module (assuming VBA code).

5. Comment out the line that is a call to ThisWorkbook.Calc_Results (assuming VBA code).

a. More lines to comment out:

b. Calc_ResultRecords, comment out the last line, “Call ShowResult Records.”

c. Empty_ResultsTables, comment out the first line, “Sheet<#>.ShowAllData.”

6. Go back into the Protection tab as described above in step #3. Check the “Lock project for viewing” checkbox. At the bottom, type in “xxxx” in the two password fields. Click OK.

7. Go to the spreadsheet window, save the spreadsheet.

a. Select Tools→Protection→Protect Workbook.

b. Check both Structure and Windows.

c. Enter “xxxx” in the password text box, then do it again.

d. Click Ok.

8. Go back to the VB window. Hide the VBA modules by doing a right click on the VBA Project title on the left side of the screen, then click “Hide.” This will hide the project components listing.

9. Close the VBA code to get back to the spreadsheet. On the Window menu, do a Window|Hide.

10. Close the spreadsheet. If it asks to save the changes, say yes.

11. Rename the spreadsheet with a .DRV extension to further hide it from the user.

12. The .DRV file is now ready to be used in the development environment. The program code will encrypt the .DRV file after the program is run once and closed.

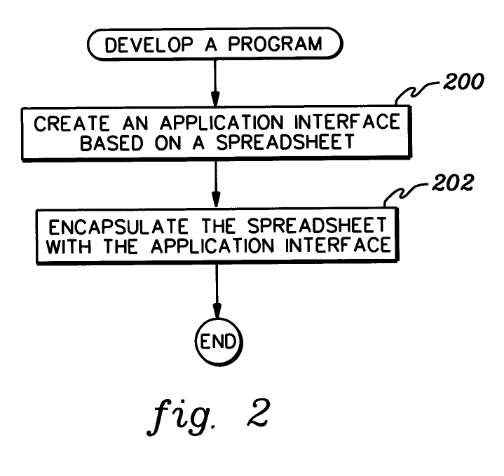

In accordance with an aspect of the present invention, the program includes a shell (e.g., the application interface) that receives inputs from a user, provides some controls on those inputs, forwards the inputs to the spreadsheet, initiates execution of logic of the spreadsheet, and displays results of the execution to the user. Further details regarding the development of such a program is described with reference to FIGS. 2-5.

Referring to FIG. 2, one embodiment of the logic associated with developing a program, in accordance with an aspect of the present invention, is described. As one example, this logic is coded using Visual Basic 6.

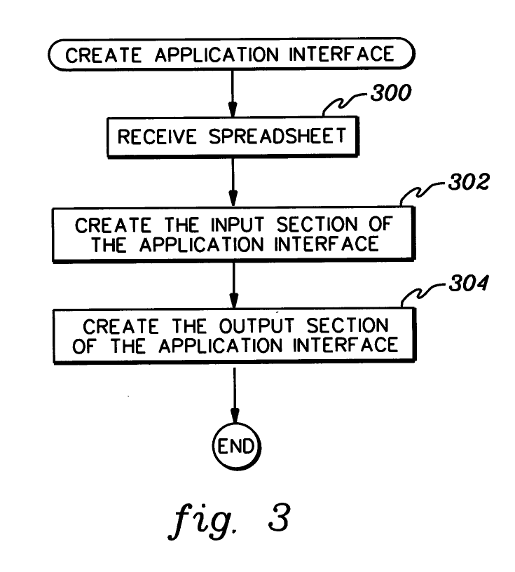

Initially, an application interface is created based on a spreadsheet provided to the program developer (a.k.a., programmer) from a user, STEP 200. The creation of an application interface is further described with reference to FIG. 3.

As one example, the programmer receives from a user a spreadsheet for which a program is to be developed, STEP 300. Since the spreadsheet is to be included within the program, the interface of the program includes various declarations associated with the spreadsheet. These declarations enable the interface to interact with the spreadsheet. As one example, the declarations include the following (for clarity, comments are provided between --):

Public appExcel As excel.Application -- This declares that an Excel Application is going to be used. --

Public exlWorkBook As excel.Workbook -- This declares that an Excel Workbook is going to be used. --

Public exlInputs As excel.Worksheet -- This declares a specific worksheet tab within the workbook. --

Public exlResults As excel.Worksheet -- This declares a specific worksheet tab within the workbook. --

In addition to the declarations, the interface includes other information to facilitate access and interaction with the spreadsheet. For example, the programmer creates an input section of the interface, which in one example is based on the inputs tab of the spreadsheet, STEP 302. That is, the design of the input section of the user interface is based on (e.g., has a look and feel of) the inputs tab of the spreadsheet. This section includes one or more data input fields, and provides certain controls not available in the spreadsheet. For example, limits are set on the input values (e.g., max, min, within a range, etc.), data types are checked, defaults are provided, etc.

As a further example, an output section of the interface is also created, STEP 304. Similar to the input section, the output section is designed based on the results tab of the spreadsheet. The output section can also include desired checks.

The interface also includes, in one embodiment, other logic that enables access to and/or interaction with the spreadsheet, as described below.

Although the interface is described herein as one interface with multiple sections, the term “interface” is defined herein to include other variations. For example, the term “interface” includes multiple interfaces of a program, such as an input interface and an output interface. It also includes interfaces that are not divided into sections.

The application interface encapsulates the spreadsheet enabling the spreadsheet to be hidden from the user and to be unchangeable by the user, STEP 202 (FIG. 2). As examples, the interface provides information to the hidden spreadsheet, initiates execution of calculations and/or other logic of the spreadsheet, and pulls information from the spreadsheet. The application interface wraps around the spreadsheet. In one example, the spreadsheet includes at least one data cell for storing data obtained from at least one data input field of the interface and at least one calculation macro.

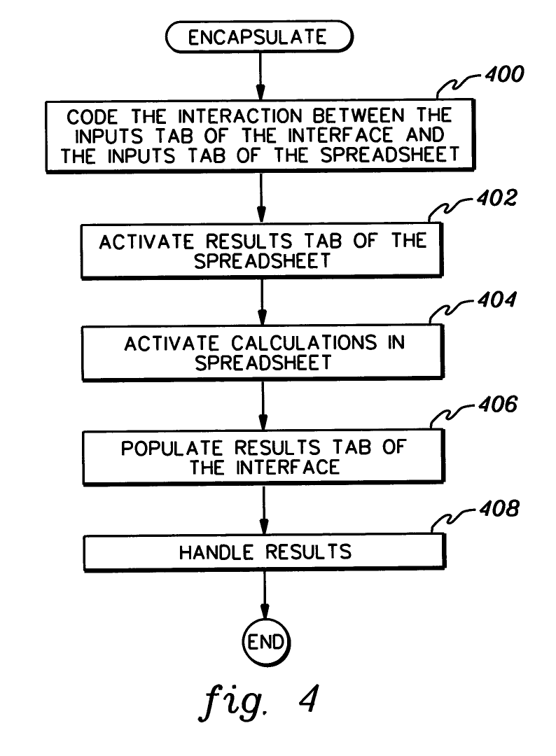

One embodiment of the logic associated with encapsulating a spreadsheet is described with reference to FIG. 4. As one example, the encapsulation logic is coded using Visual Basic 6 and is included within the interface. Referring to FIG. 4, one step of the encapsulation includes coding the interaction between the inputs tab of the interface and the inputs tab of the spreadsheet, STEP 400. This step allows the information provided by the user to be transferred to the spreadsheet and used in execution of the spreadsheet, as described in further detail below.

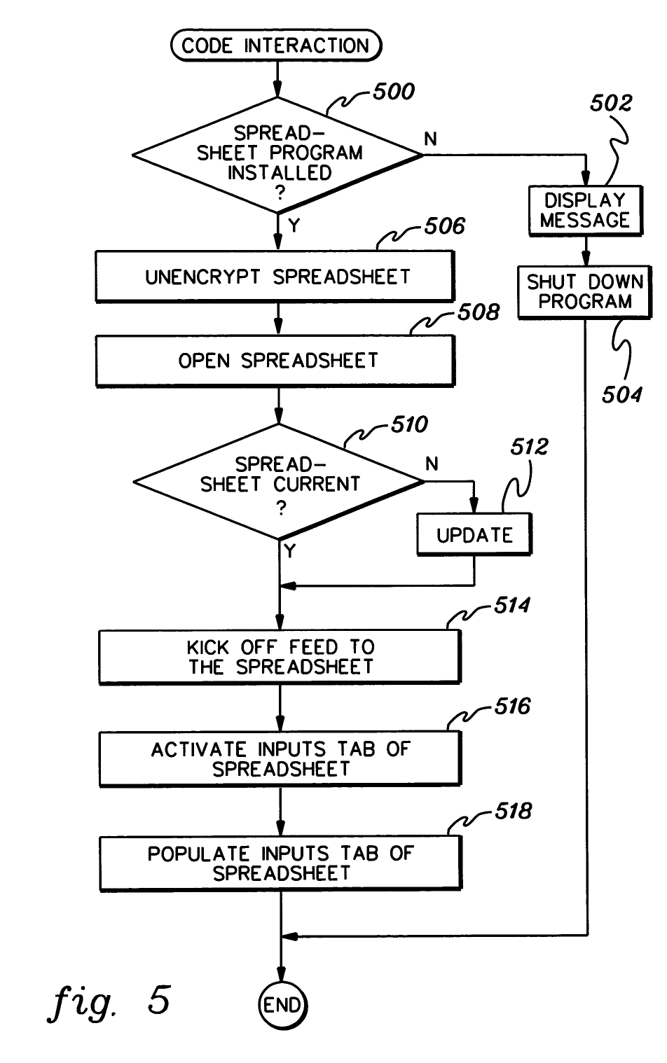

One embodiment of the logic associated with the interaction coding is described in detail with reference to FIG. 5. Although various steps are described herein, it will be apparent to those skilled in the art that steps may be added, deleted and/or changed without departing from the spirit of the present invention.

Referring to FIG. 5, the coding includes determining whether a spreadsheet program (such as, for instance, Excel) is installed, INQUIRY 500. If a spreadsheet program is not installed, then an appropriate message is displayed, STEP 502, and the program is shutdown, STEP 504. However, if the spreadsheet program is installed, then the spreadsheet is unencrypted, STEP 506. In one example, this includes renaming the spreadsheet with a .DRV extension. As a further example, the following Visual Basic code is used to unencrypt the spreadsheet:

If AppLevelVars.ApplyEncryption Then
sDummy = CreateWorkFile(strXLSTemplate)
End if

Further, the spreadsheet is opened providing any required passwords, STEP 508. In this embodiment, one or more passwords are used, since the spreadsheet is not visible to the user. One example of the Visual Basic code used to open the spreadsheet is as follows (for clarity herein, comments are between --):

```
-- The following calls the function that opens the spreadsheet.
If it is not opened correctly, an error message is displayed. (In
the text below, SSM (Standard Solution Module) is the
program being developed.)--
If Not getExcel(True,sXLSTemplate) Then
    SSM_MsgBox or SSMGlobal, gEXCEL_DRIVER_PROBLEM
    AppLevelVars.IsExcelLoaded = False
    Exit Sub
Else
    AppLevelVars.IsExcelLoaded = True
End If
-- To open the spreadsheet --
If createNew Then
    Set dbExcel = New ExcelObject -- Set the Excel Object --
    dbExcel.Excel_App.Visible = False -- Make sure the spreadsheet
    is not visible --
    --Open the spreadsheet with the appropriate settings and passwords--
    dbExcel.Excel_App.Workbooks.Open strXLSTemplate,
    ReadOnly:=False, Password:= “xxx”, WriteResPassword:= “xxx”,
    ignore ReadOnlyRecommended:=True
End If
```

Thereafter, a determination is made as to whether the spreadsheet is current, INQUIRY 510. For example, various rates provided in the spreadsheet are checked against rates stored in a database, such as an Access database, to ensure that the latest rates are provided in the spreadsheet. If the spreadsheet is not up-to-date, then the Access database is used to update the spreadsheet, STEP 512. This updating is performed via the application interface. To save the updated spreadsheet, the following code is used, in one example:

dbExcel.Excel_App.Workbooks(AppLevelVars.SpreadsheetDriverName).Save

Further, or if the spreadsheet is current, then the user kicks off the feed to the spreadsheet by clicking on the results tab of the user interface, STEP 514. This begins the interaction between the interface and the spreadsheet. With Visual Basic 6, the program sets the focus to activate the inputs tab of the spreadsheet, STEP 516. In one example, this includes:

Set exlInputs =
dbExcel.Excel_App.Workbooks(AppLevelVars.SpreadsheetDriverName).
Sheets
(“Inputs”)

The inputs tab of the spreadsheet is populated with the values provided by the user on the application interface, STEP 518. This population includes verifying that the entries provided by the user in the Visual Basic application are transferred to the spreadsheet appropriately. Population can be performed in a variety of ways including assigning the data one cell at a time, providing a range of data and/or using a copy and paste function. Code examples used to populate the spreadsheet are provided below:

```
-- Example of how to set a value in a cell in the spreadsheet: --
    exlInputs.Cells(iRow, 2).Value = piGroupStartMonth
--To copy a section of a grid from the interface and paste it into the spreadsheet --
    --Remove DRV file protection and unhide the window --
        dbExcel.Excel_App.Workbooks (AppLevelVars.SpreadsheetDriverName).
        Unprotect -- unprotect the spreadsheet --
        dbExcel.Excel_App.Workbooks (AppLevelVars.SpreadsheetDriverName).
        Activate -- activate the spreadsheet --
        dbExcel.Excel_App.Workbooks (AppLevelVars.Spreadsheet DriverName).
        Worksheets(“Inputs”).Activate -- activate the inputs tab --
        dbExcel.Excel_App.Windows(1).Visible = True -- make spreadsheet
        visible to the code, but it is not visible to the user --
    --Copy from interface —e.g., select the first block of Services
        Details inputs and copy to clipboard--
        grdServicesDetail.Row = MatrixSwitchDACS
        grdServicesDetail.Col = 4
        grdServicesDetail.Row2 = TotalInfrastructureDevices
        grdServicesDetail.Col2 = grdServicesDetail.MaxCols
        grdServicesDetail.BlockMode = True
        grdServicesDetail.Action = SS_ACTION_SELECT_BLOCK
        Clipboard.Clear
        grdServicesDetail.Action = SS_ACTION_CLIPBOARD_COPY
    --Paste to spreadsheet -- e.g., paste the grid details from the clipboard to the
        ServicesDetail1 range --
        dbExcel.Excel_App.Workbooks(AppLevelVars.SpreadsheetDriverName)
        .ActiveSheet.Paste
        Destination:=Worksheets(“Inputs”).Range(“ServicesDetail1”)
    --Deselect the block of Services Detail1 inputs --
        grdServicesDetail.Action = SS_ACTION_DESELECT_BLOCK
```

Subsequently, the spreadsheet is protected and re-hidden.

--Protect and re-hide the DRV window --
dbExcel.Excel_App.Workbooks(AppLevelVars.SpreadsheetDriverName).
Protect (“xxxx”)
dbExcel.Excel_App.Windows(1).Visible = False

Returning to FIG. 4, in addition to coding the interaction, the encapsulation includes enabling other tasks, which are, for instance, coded in Visual Basic 6. One of these tasks includes activating the results tab of the spreadsheet, STEP 402. In one example, this is performed by the following:

Set exlResults =
dbExcel.Excel_App.Workbooks(AppLevelVars.SpreadsheetDriverName).
Sheets(“Results”)

Additionally, in one example, a Visual Basic command is sent to the spreadsheet to activate one or more calculation commands in the spreadsheet, STEP 404. This step is performed if there are calculations in VBA (Visual Basic for Applications) code in the spreadsheet. If there are no such calculations, but instead, the calculations are in the cells of the spreadsheet itself, then this step need not be performed. Instead, the calculations are automatically invoked based on input data.

One example of the code used to activate a command in VBA is as follows:

--Call and execute the calculate results function within the spreadsheet --
dbExcel.Excel_App.Run “SpreadsheetName.drv!ThisWorkBook.Calc_{—}
ResultRecords”
-- Run the VBA code in the spreadsheet --

In response to receiving the command, the spreadsheet executes logic of the spreadsheet. For instance, the spreadsheet executes at least one calculation macro on at least one data cell of the spreadsheet. By enabling the use of the spreadsheet as a calculation engine, the calculations and/or other logic of the spreadsheet need not be re-coded in Visual Basic or any other programming language.

The results of the calculation(s) are pulled from the spreadsheet results tab and used to populate a grid control on the results tab of the user interface, STEP 406. In one example, there are a plurality of branch levels of results, and each level includes one or more groups. Thus, in this example, the loading includes loading the highest branch level of the spreadsheet results and its values into a Visual Basic array; loading the next highest branch level of the spreadsheet results and its values into the array; etc. Then, loading the groups listed in the spreadsheet into the array. This continues for any further levels of results that may be present. The array is then used to populate the results tab of the user interface. This allows the user to move through each level using drop down boxes. Each time the user changes the drop down, that selection is pulled from the array and displayed to the user.

To facilitate population of the results tab, the results are placed in an array. One example of code used to place the results in an array is as follows:

```
-- This code goes to the results tab and gets a record (row) count and a
    column count of a selected range within the spreadsheet.--
    Set exResults =
    dbExcel.Excel_App.Workbooks (AppLevelVars.
    SpreadsheetDriverName).
        Sheets(“Results”)
      iRecordCount = exlResults.Range(“Results_{—}
        Table”).Rows.Count
      iColumnCount = exlResults.Range(“Results_{—}
        Table”).Columns.Count
--This puts the spreadsheet range values into an array so it can be
    used by the user interface: --
    ReDim marySkillsResults(1 to iRecordCount, 1 To
        iColumnCount)
        jCol = 1
        iRow = 0
    -- For each cell in this range, add that value to the array --
    For Each vCell In exlResults.Range(“Results_Table”)
        If Not (iRow = 0) Then
            marySkillsResults(iRow,jCol) = vCell.Value
        marySkillsResults(iRow,jCol)
        End If
    --Keep track of columns and record count for the grid --
        jCol = jCol+1
        If jCol = (iColumnCount + 1) Then
                If iRow < iRecordCount Then
                    iRow = iRow + 1
                    jCol = 1
                End If
        End If
        Next vCell
```

In addition to the above, the encapsulation code optionally includes code to handle the results, STEP 408. For example, the user checks the results received from running the spreadsheet. If the results are not satisfactory to the user, then the user can go back to the inputs tab of the user interface, revise the values, and repeat the process. However, if the user is satisfied with the results, the user performs an export to place the values in the collection into the Access database with an extension appropriate to the branch levels it contains. The user can then decide to exit the program. If the user decides to exit the program, the code closes the spreadsheet and the spreadsheet is encrypted. The following code is used, as one example:

```
-- This calls a program to reencrypt the spreadsheet. The
    encryption program can be one of many programs. It is
    called, for instance, when the user is closing the application
    interface. --
    CloseWorkFile (sXLSTemplate)
-- This closes the spreadsheet --
    If not dbExcel.Excel_App.Workbooks(AppLevelVars.
        SpreadsheetDriverName) Is Nothing Then
    dbExcel.Excel_App.Workbooks(AppLevelVars.
    SpreadsheetDriverName).
        Close False
    End if
    If dbExcel.Excel_App.ActiveWorkbook Is Nothing Then
        dbExcel.Excel_App.Quit
    End If
    Set dbExcel.Excel_App = Nothing
```

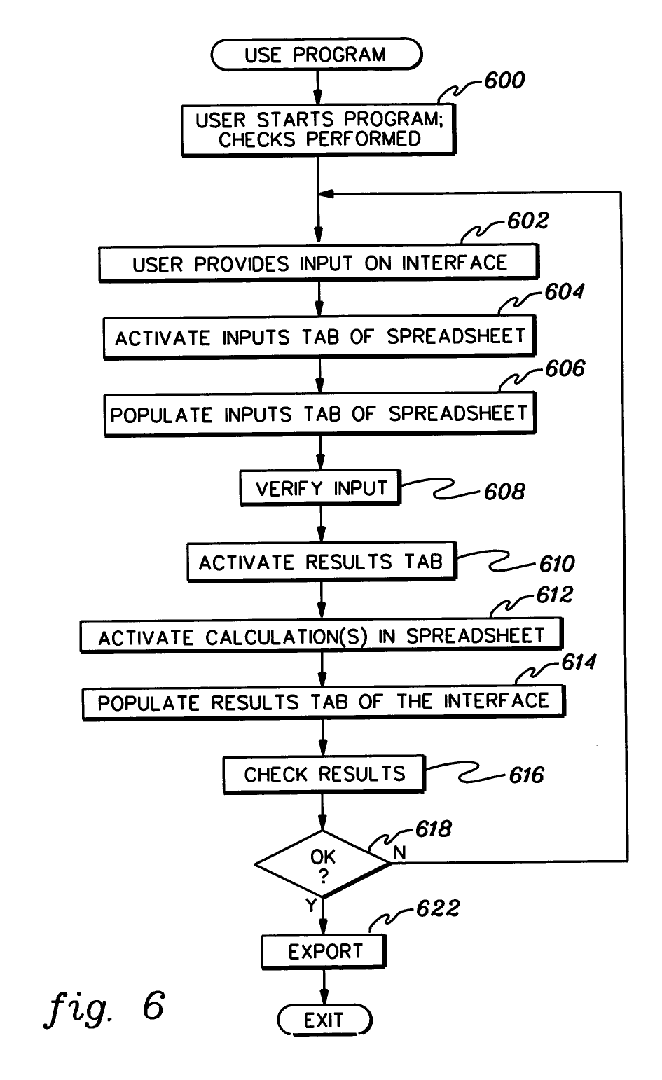

One embodiment of the logic associated with using the developed program in which the spreadsheet is encapsulated and hidden from the user is described with reference to FIG. 6. Initially, the user starts the Visual Basic program to display the application interface to be used by the user, STEP 600. As described above, when the program is started, certain checks are performed. These include, for instance, determining whether the user has a spreadsheet program installed and determining whether the spreadsheet is current. Further, other tasks are performed, including opening and unencrypting the spreadsheet.

The user provides input on the application interface, STEP 602. Further, the inputs tab of the spreadsheet is activated, STEP 604, and the user provided information on the application interface is used to populate the inputs tab of this spreadsheet, STEP 606. The inputs tab information is then verified, STEP 608. In one example, this includes verifying that the entries entered in the Visual Basic application were transferred to the spreadsheet appropriately.

Moreover, the results tab is activated, STEP 610, and a Visual Basic command is sent to the code of the spreadsheet to activate a calculation command in the spreadsheet, STEP 612. In response to executing the calculation command, values are placed in the spreadsheet results tab. Those values are pulled and used to populate the results tab of the application interface, STEP 614. As described above, this includes loading the highest branch level of the spreadsheet results and its values into an array, loading the next highest branch level of the spreadsheet results and its values into the array, etc. Further, the groups listed in the spreadsheet are also loaded into the array. The array is then used to populate the results tab of the user interface. This allows the user to move through each level using drop down boxes. Each time a user changes the drop down that selection is pulled from the array and displayed to the user.

In addition to the above, the user checks the results, STEP 616. If the user is unsatisfied with the results, INQUIRY 618, then the user returns to the inputs tab of the application interface to provide revised values and processing continues therefrom. However, if the user is satisfied with the results, the user performs an export to place the values in the collection into the Access database with an extension appropriate for the branch levels it contains, STEP 622. The user may then decide to exit the application. Upon exit, the code closes the spreadsheet. The spreadsheet inputs and results are not saved. However, if the user chooses to the save the inputs first, then those values are saved in the Access database to which the user has given a unique name. The spreadsheet is again encrypted. If the user reopens the saved database file, the values that had been saved are loaded into the user interface. When the user clicks on the results tab of the interface, processing continues with STEP 604.

Described in detail above is a capability that facilitates the development of a program that is based on a spreadsheet. The logic within the spreadsheet is not re-coded, but instead, is used in and of itself as part of the program. The user's inputs are fed into the spreadsheet, the spreadsheet performs the logic (e.g., calculations), and the results are posted back to the interface. The interface is, for example, the exclusive input/output access of the spreadsheet. This allows business logic that is easy to build in a spreadsheet to be encapsulated by a program that is provided to users, while being able to hide the spreadsheet and logic from the users.

Advantageously, functionality of the spreadsheet is provided, allowing users to enter values, have estimates or modeling performed, and receive results, using an application interface. The end user does not deal directly with the spreadsheet, and other functionalities desired in the final application program can be incorporated seamlessly into the program. This enables the value of a spreadsheet to be provided in a more controlled environment of a program. The functionality of the spreadsheet is not compromised and either is the integrity of the spreadsheet, since the spreadsheet is hidden from the user. The user is not aware that the spreadsheet is being used, and input and output access to the spreadsheet is exclusively performed via the interface. The use of the product by the user is controlled.

Advantageously, the development period for this type of a program has been reduced from, for example, approximately three months to approximately two weeks. This reduces the number of developers needed on a task, saves development time and saves the company and its customers money. Further, any changes to an existing calculation simply requires the replacing of the existing spreadsheet without requiring coding, since the calculations are not re-coded.

Although one example of a computing environment is provided above, this is only one example. Other computing environments may be used without departing from the spirit of the present invention. As examples, other types of computers, operating systems, programming languages and/or spreadsheet programs may be used. Further, although an example of steps to be performed to password protect the spreadsheet is provided, in other examples, other steps may be used.

The present invention can be included in an article of manufacture (e.g., one or more computer program products) having, for instance, computer usable media. The media has therein, for instance, computer readable program code means or logic (e.g., instructions, code, commands, etc.) to provide and facilitate the capabilities of the present invention. The article of manufacture can be included as a part of a computer system or sold separately.

Additionally, at least one program storage device readable by a machine embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

Although preferred embodiments have been depicted and described in detail herein, it will be apparent to those skilled in the relevant art that various modifications, additions, substitutions and the like can be made without departing from the spirit of the invention and these are therefore considered to be within the scope of the invention as defined in the following claims.

What is claimed is:

1. A method of facilitating development of programs, said method comprising:
providing an interface of a program; and
including in the program a spreadsheet that is to execute logic of the spreadsheet in response to data of the interface, wherein the spreadsheet of the program is unchangeable by a user.

2. The method of claim 1, wherein the spreadsheet of the program is hidden from the user.

3. The method of claim 1, wherein having the spreadsheet execute logic of the spreadsheet avoids re-coding of logic of the spreadsheet.

4. The method of claim 1, wherein the providing comprises creating the interface based on the spreadsheet.

5. The method of claim 4, wherein the creating comprises:
creating an input section of the interface based on an input tab of the spreadsheet; and
creating an output section of the interface based on a results tab of the spreadsheet.

6. The method of claim 1, wherein the including comprises enabling interaction between the interface and the spreadsheet.

7. The method of claim 6, wherein the enabling interaction comprises providing to the spreadsheet one or more inputs from the interface.

8. The method of claim 7, wherein the enabling comprises performing at least one of one or more checks and one or more tasks in preparation of the providing.

9. The method of claim 1, further comprising enabling the interface to provide output data from the spreadsheet.

10. The method of claim 1, wherein the logic comprises one or more calculations to be performed on data provided by the interface.

11. The method of claim 10, further comprising enabling the interface to provide one or more results of at least one calculation of the one or more calculations.

12. The method of claim 1, wherein the interface provides exclusive input access to the spreadsheet of the program.

13. The method of claim 1, wherein the interface provides exclusive output access to the spreadsheet of the program.

14. The method of claim 1, further comprising replacing one or more calculations of the spreadsheet and avoiding re-coding of the interface.

15. A method of facilitating access to spreadsheets, said method comprising:
using an interface to provide data to a spreadsheet, said interface providing exclusive input access to the spreadsheet; and
using the interface to obtain data from the spreadsheet, said interface providing exclusive output access to the spreadsheet.

16. The method of claim 15, wherein the interface encapsulates the spreadsheet, and wherein the encapsulated spreadsheet is hidden from one or more users.

17. The method of claim 15, wherein the interface encapsulates the spreadsheet, and wherein the encapsulated spreadsheet is unchangeable by one or more users.

18. The method of claim 15, wherein at least a portion of the data to be obtained from the spreadsheet is based on one or more calculations performed by the spreadsheet.

19. A system of facilitating development of programs, said system comprising:
means for providing an interface of a program; and
means for including in the program a spreadsheet that is to execute logic of the spreadsheet in response to data of the interface, wherein the spreadsheet of the program is unchangeable by a user.

20. The system of claim 19, wherein the spreadsheet of the program is hidden from the user.

21. The system of claim 19, wherein the means for providing comprises means for creating the interface based on the spreadsheet.

22. The system of claim 19, wherein the means for including comprises means for enabling interaction between the interface and the spreadsheet.

23. The system of claim 22, wherein the means for enabling interaction comprises means for providing to the spreadsheet one or more inputs from the interface.

24. The system of claim 19, further comprising means for enabling the interface to provide output data from the spreadsheet.

25. The system of claim 19, wherein the logic comprises one or more calculations to be performed on data provided by the interface.

26. The system of claim 19, wherein the interface provides at least one of exclusive input access and exclusive output access to the spreadsheet of the program.

27. The system of claim 19, further comprising means for replacing one or more calculations of the spreadsheet and avoiding re-coding of the interface.

28. A storage to store a computer program, said computer program comprising:
an interface; and
a spreadsheet that is to execute logic of the spreadsheet in response to data of the interface, wherein the spreadsheet of the program is unchangeable by a user.

29. An article of manufacture comprising:
at least one computer usable medium having computer readable program code logic to facilitate development of programs, the computer readable program code logic comprising:
provide logic to provide an interface of a program; and
include logic to include in the program a spreadsheet that is to execute logic of the spreadsheet in response to data of the interface, wherein the spreadsheet of the program is unchangeable by a user.

30. The article of manufacture of claim 29, wherein the spreadsheet of the program is hidden from the user.

31. The article of manufacture of claim 29, wherein the provide logic comprises create logic to create the interface based on the spreadsheet.

32. The article of manufacture of claim 29, wherein the include logic comprises enable logic to enable interaction between the interface and the spreadsheet.

33. The article of manufacture of claim 32, wherein the enable logic comprises provide logic to provide to the spreadsheet one or more inputs from the interface.

34. The article of manufacture of claim 29, further comprising enable logic to enable the interface to provide output data from the spreadsheet.

35. The article of manufacture of claim 29, wherein the logic of the spreadsheet comprises one or more calculations to be performed on data provided by the interface.

36. The article of manufacture of claim 29, wherein the interface provides at least one of exclusive input access and exclusive output access to the spreadsheet of the program.

37. The article of manufacture of claim 29, further comprising replace logic to replace one or more calculations of the spreadsheet and avoid re-coding of the interface.

38. An article of manufacture comprising:
at least one computer usable medium having computer readable program code logic to facilitate access to spreadsheets, the computer readable program code logic comprising:
use logic to use an interface to provide data to a spreadsheet, said interface providing exclusive input access to the spreadsheet; and
use logic to use the interface to obtain data from the spreadsheet, said interface providing exclusive output access to the spreadsheet.

39. The article of manufacture of claim 38, wherein at least a portion of the data to be obtained from the spreadsheet is based on one or more calculations performed by the spreadsheet.
